(19) United States
(12) Patent Application Publication
(10) Pub. No.: US 2010/0126806 A1
(43) Pub. Date: May 27, 2010

(54) APPARATUS AND METHOD FOR FORMING COLUMNS

(75) Inventor: Mike Kerr, Anaheim, CA (US)

Correspondence Address: FOLEY & LARDNER LLP, P.O. BOX 80278, SAN DIEGO, CA, 92138-0278, US

(73) Assignee: McCarthy Building Companies, Inc.

(21) Appl. No.: 12/277,224

(22) Filed: Nov. 24, 2008

(51) Int. Cl. B66F 9/18; B66F 9/06

(52) U.S. Cl. 187/237; 414/816

(57) ABSTRACT

An apparatus for use with construction of concrete through forms comprises a fixture attached to a lifting vehicle, a vertical component having an inner portion and an outer portion, a base component configured to support the vertical component, the base component having two or more parallel portions crossing two or more perpendicular parallel portions, and two or more brackets on the vertical component, wherein the brackets contain hook elements on one side.

### BACKGROUND OF THE INVENTION

The present invention relates generally to the field of construction. In particular, the present invention relates to the use of plumbing forms to form columns.

Conventional methods of constructing concrete-poured columns rely on inefficient and unsafe techniques. Such methods often rely on cranes or lifting trucks utilized in a manner similar to cranes. This approach can be problematic since proper alignment is required when placing the column forms, or temporary structures must be erected to mold the poured, wet concrete into columns. The forms are typically attached to rigging which is lifted by the cranes for placement. Typically, the tops of the forms are attached to the rigging. When the forms are positioned onto a rebar cage, the rigging often interferes with the cage.

This interference can result in misalignment between the centerline of the rigging and the rebar cage. Such misalignment often causes instability, such as tilting of the bottom of the form away from the cage, resulting in unbalanced forces on the rig. Manual force may be required to straighten and align the form to plumb with the rebar. Often this task can require multiple workers.

After manual force is applied to push the form towards the rebar, the form must then be attached or closed when in place. The closing of the form can be particularly dangerous because the form is not only very heavy, but can also shut suddenly and with great force when the forms are maneuvered around the columns.

Further, in such conventional methods, when the form is pushed into place around the rebar and plumb, the form must be held or anchored in place by manual force. Typically, this can require multiple workers, depending on the weight and size of the form. During the anchoring, additional workers may be required to wrap around and close the form while also dealing with substantial weight from the form, as well as unbalanced forces from the rigging cable on the form. Thus, the conventional process creates a very awkward, dangerous and inefficient work environment, risking injuries to workers and/or damage to the forms/cage.

### SUMMARY OF THE INVENTION

One aspect of the invention relates to an apparatus for use with construction of concrete through forms. The apparatus comprises a fixture attached to a lifting vehicle, a vertical component having an inner portion and an outer portion, a base component configured to support the vertical component, the base component having two or more parallel portions crossing two or more perpendicular parallel portions, and two or more brackets on the vertical component, wherein the brackets contain hook elements on one side.

In one embodiment, the outer portion of the vertical component is a hollow metal pipe. In anther embodiment the pipe measures between about 4 and about 6 inches in diameter. In a further embodiment, the pipe has a wall with a thickness of about ½ inches. In yet another embodiment, the outer portion of the vertical component is welded to a bearing plate.

In one embodiment, the outer portion of the vertical component is rotatable about the inner portion. Yet another embodiment provides that the inner portion of the vertical component is a solid pole fitted within the outer portion. In one embodiment, the inner portion is between about 3 and about 5 inches in diameter. Another embodiment provides that the vertical component contains notches that are spaced apart. In one embodiment, at least one bracket is vertically adjustable on the vertical component.

In one embodiment, the bracket is configured to be adjusted and secured with a bolt through one of the notches located on the vertical component. In one embodiment, the bolt is between about 0.5 and about 1.5 inches in diameter. In another embodiment, the brackets include a brace. Another embodiment provides that the base component includes two or more tube portions. In another embodiment, the vertical component includes a bearing plate having a hole for insertion of the inner portion of the vertical component therethrough. In one embodiment, the bearing is about ⅞ inches thick. In one embodiment, a lower bracket is attached to the vertical component.

Another aspect of the invention relates to a method of plumbing forms. The method comprises attaching a form to an apparatus, the apparatus having a vertical component, a base component and two or more brackets containing hooks and located on the vertical component. The method further comprises adjusting at least one bracket about the vertical component, aligning the form and plumbing the form.

### BRIEF DESCRIPTION OF THE DRAWINGS

FIG. 1 illustrates a side view of an exemplary form with attachments and an apparatus in accordance with an embodiment of the present invention.

FIG. 2 illustrates a view of an upper hook element of the apparatus in accordance with an embodiment of present invention.

FIG. 3 illustrates a view of a lower hook element of the apparatus in accordance with an embodiment of present invention.

FIG. 4 illustrates an overhead view of a base element of the apparatus in accordance with an embodiment of the present invention.

FIG. 5 illustrates a horizontal base element containing the vertical pole element in accordance with an embodiment of the present invention.

### DETAILED DESCRIPTION OF THE CERTAIN EMBODIMENTS

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions.

Embodiments of the present invention overcome the above-described shortcomings of conventional systems and methods by providing a simple apparatus and method that allows for easy positioning, plumbing and attachment of the forms.

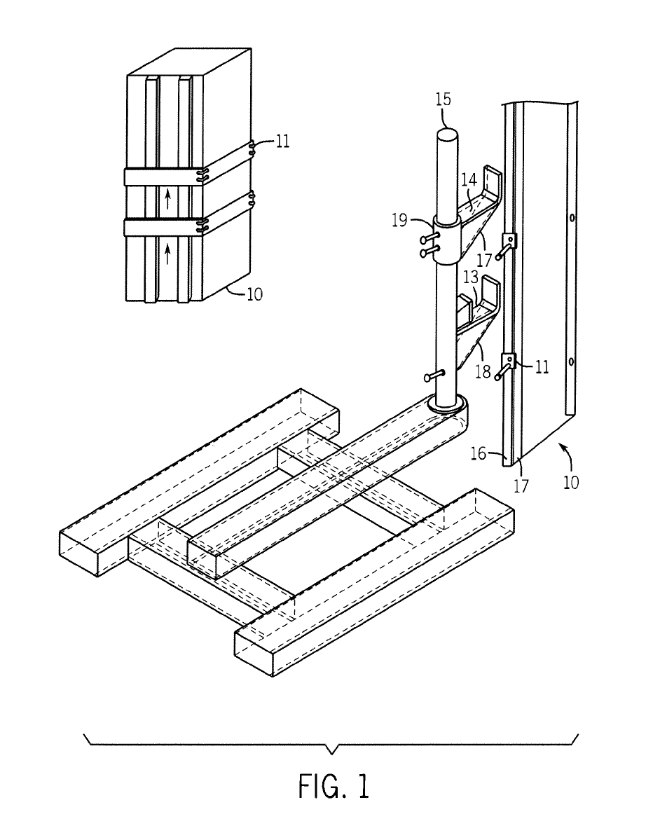

Referring to FIG. 1, an exemplary embodiment of the present invention is illustrated. Usage of the apparatus with a column form 10 will be described with reference to FIG. 1. A column form 10 is the temporary structure erected to contain wet concrete, similar to a molding. In accordance with embodiments of the present invention, these forms mainly pertain to columns for erecting large buildings, for example. However, other forms, such as wall forms and other types of forms, are also contemplated and considered within the scope of the present invention. Thus, the present invention is not limited to column-type forms and may be applicable to other applications of form placement and maneuvering.

There are many types of column forms also available, dependent on the shape, size, usage amount and maneuverability desired. Some column forms come with hinged sides, that are locked together on that are known as gates. These may entail the Lok-Fast type forms, for example. Further, materials of column form structures may include fiberglass forms, steel forms and paper forms, for example. In an exemplary embodiment of the present invention, a column wood form 10 is provided that has plywood pieces bolted to 2-inch wide by 4-inch long (2×4) pieces of wood. This structure is held together with column clamps 11. The clamps 11 are utilized to secure and maintain the form structure. In the illustrated embodiment of FIG. 1, the inner vertical plywood component 17 is made of old HDO plywood, while the outer vertical plywood component 16 is made of new HDO plywood. The apparatus of FIG. 1 includes adjustable brackets 13, 14. The adjustable brackets 13, 14 include a sleeve portion 16, which is fitted around the vertical component 15, and hook-type edges, which may attach to lips contained in the clamps 11, as illustrated in the embodiment of FIG. 1. Thus, when the apparatus is lifted, the column form is also lifted.

Due to the sleeve portions, the adjustable bracket 14 of the apparatus is not only adjustable by height, but also rotatable and removable when located on a vertical component 15 of the apparatus. Again, the sleeve portion 19 of the bracket, which is fitted a substantial portion or completely around the vertical component 15 and made from about a 6 inch diameter pipe, enables the rotation without being too unsteady or weak. The actual bracket arms, or supports, 17, 18 are welded onto the sleeve portions for the additional support and strength. Thus, in one embodiment, both brackets 13, 14 may be moved up and down or rotate around the vertical component 15 which extends upwards on one side of the apparatus. In another embodiment, as mentioned above, only the top bracket may be adjustable about the vertical pole component 15. These sleeves, along with the overall bracket, are secured in place with large coil bolts that may be 2⅛ inch diameter ended, 1 inch diameter bolt. A ¾ inch coupler nut may be welded onto the sleeve portion of the bracket in order for secure placement. Accordingly, divots are located along an inner pole of the assembly in order for the bolts to screw through an opening on the outer pole, while still making substantial contact with inner pole.

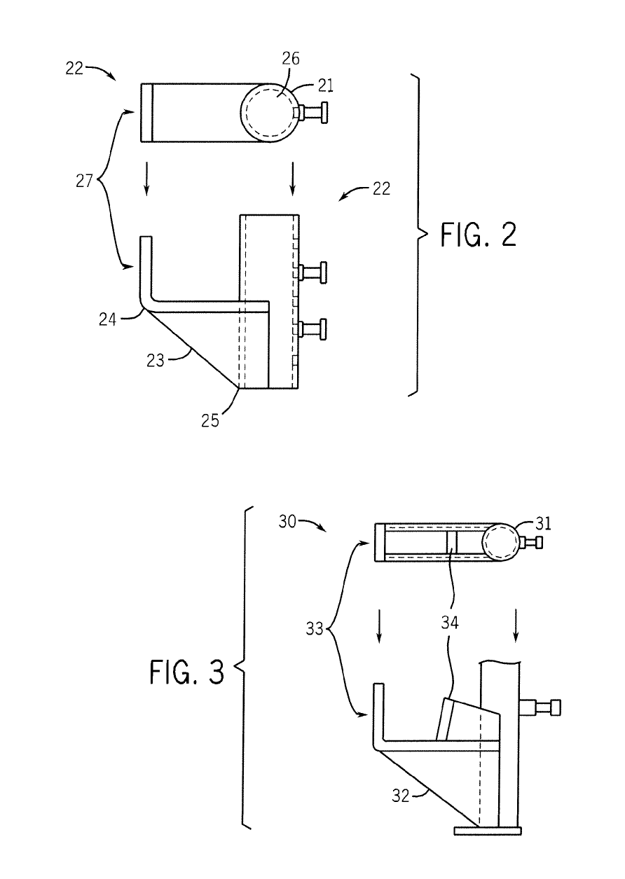

FIG. 2 illustrates a top view mapped to a side view of bracket 13, respectively. The top view shows an aerial view down the pole 21 with the bracket 20 extending outward to the left, while the side view provides a rotation of the pole/bracket assembly. The upper bracket 20, may be adjusted along the vertical pole 21 through usage of 1 inch-coil bolts which fit into holes or divots 22 that may be drilled along one side of the pole. The bolts may be thread through a ¾ inch-coupler nut which is welded onto the bracket sleeve structure for security. In one embodiment, these holes or divots 22 may be approximately 2 inches apart. In one embodiment, where the feature 22 are holes, the holes may be drilled through the outer vertical pole as well as through the inner solid pole. In some embodiments, the holes may be drilled through the outer vertical pole, and only divot portion may be made within the inner pole. For lighter loads, the holes may only be drilled through the sleeve portion of the brackets and secured through divots on the outer vertical pole. Of course, other similar configurations may be made according to load types and preferences. Further, these holes or divots 22 may also be modified according to specific types of forms being frequently utilized. In addition, the bracketed hooks may be adjusted or even welded and modified to specific angles to which the form is to be plumbed. This may be done by the bracket or by the angling of the entire apparatus with the brackets remaining with hooks perpendicular to the vertical pole portion of the apparatus. The upper bracket may also contain a brace 23 underneath which will aid in the strain placed on the hook structure during lifting of the heavy column forms. The brace 23 may extend from the outer edge of the hook 24 on the bracket to the base of the bracket 20 itself. As well, it may be welded to the vertical portion of the bracket and bottom 25 of the hook 24 in order to secure it.

The bracket may reside along an outer vertical pole 21 that is hollow and fitted around the inner solid pole of the apparatus. This will allow for the holes to be made more easily through it, in order to hold the bracket in place by the bolts. The vertical pole 21 is preferably 5 inches in diameter, but may vary in size to accommodate larger, heavier loads as well as smaller loads. The outer vertical pole 21 is preferably made from steel or another sturdy metal which can accommodate heavy loads. The outer vertical pole ends at the base portion of the apparatus and may be attached through welding to a bearing portion. The bearing portion may be approximately ⅞ inch thick and approximately 5 inch diameter. This will allow the outer vertical pole 21 to rotate. The outer vertical, hollow pole is further secured to the base portion during usage of the apparatus through an inner solid pole. The inner pole provides may be approximately 4 inches in diameter. However, the inner pole may be smaller or larger in diameter according to size variations of the outer vertical pole 21 and apparatus as a whole. The inner pole may extend vertically to approximately full or a portion of the length of the vertical pole depending on the amount of weight the pole is to sustain. The inner pole is to be connected to a through the lower bracket and base tubed portion through welding for additional structure security.

The hook portion 24 of the upper bracket 20 may extend far enough away from the vertical portion of the bracket in order to accommodate a 2×4. In one embodiment, the length may be approximately 6½ inches between the lip, or hook, portion and the outer diameter of the vertical pole. As well, this may be a further distance or shorter distance, dependent on the form design. The width of the hook portion 24 may be approximately the same as the diameter of the bracket portion. In a preferred embodiment, the hook portion 24 is approximately 4 inches wide. In addition, the hook portion 24 may be welded to the bracket 20. The lip portion 27 of the hook may extend vertically approximately 4½ inches, or enough to secure the load of the form to be plumbed. In addition, this may be longer or shorter, dependent on the form with which the apparatus is to be utilized. However, is should not be long enough to inhibit easy placement and removal of the apparatus from the form, or short enough to possibly lose hold of the form during movement. In order for further facilitation during loading and placement, the top 2 inch of the lip may be slanted. The bracket 20 is secured in place through use of a bolt which may be approximately 8 inches long and 1 inch in diameter which will ensure that the bracket will not move during movement of the form. The 1 inch coil bolt is secured through a ¾ inch coupler nut which may be welded to the bracket. As previously discussed, the bolt may extend through a hole in outer vertical pole and inner solid pole, or only a portion thereof with divots.

The special configuration of the hooking fixture apparatus and the manner in which it can be utilized in conjunction with the lift truck to accomplish the tasks of form positioning and form removal from the side, rather than from the top of the forms with use of a crane and rigging is unique within the industry. The novel configuration of the hook elements and their adjustability to facilitate exact alignment and positioning of the forms also provides an improvement within the industry. Though it is provided within the present embodiment to utilize one upper adjustable bracket and one lower non-adjustable bracket, this may be modified. Multiple adjustable bracket may be utilized dependent on their necessity do to load sizes and column form lengths to be used in a particular structural development. These brackets may be added onto the top of the vertical pole as needed and taken off as needed.

FIG. 3 shows an embodiment wherein the lower bracket 30 may be welded directly to the outer vertical pole portion 31 of the apparatus. However, due to this direct welding, the additional sleeve portion, as discussed with the top adjustable bracket, is unnecessary. This may be done in order to form an even more secure base portion of the apparatus. Similar to the upper bracket, the lower non-removable bracket may also have a brace portion 32 for further support of large loads. In addition, the lower bracket may have two lip, or hook, portions 33, 34 extending horizontally away from the vertical portion of the bracket. The first portion 33, extending vertically approximately 4½ inches at approximately 6½ inch away from the vertical pole component. The outer hook portion may also slant inward at the top 2 inch to facilitate loading and unloading, similar to the top bracket hook portion. is similar to that on the upper bracket. However, the secondary portion 34 extends vertically only a portion of the height of the first portion, at approximately 3⅜ inch and approximately 1½ inch away form the vertical pole component. The lower bracket may be welded directly to the outer vertical pole 31 of the vertical component of the apparatus. This will ensure that it will not move or adjust during movement of the forms, only being rotatable with the entire outer vertical pole. The bracket 30 and brace 32 components may be cut to a length of approximately 9 5/16 inch (including the bearing plate) to the top of the inner lip portion and extending along the centerline of the vertical pole component, along with the brace component being cut to an extended length and welded to the outer vertical pole in order to accomplish this set-up. The inner pole is attached to a base portion through the bearing plate and center tube support. The bearing plate may have a 2 inch hole through which the inner pole is situated and welded into a lower 6 inch diameter semi-circle portion located at the end of the center tube portion of the apparatus.

The inner rod, or solid pole, may be welded to the upper bearing plate under the plate in order to keep the plate flat on the top portion and allow the outer vertical pole to rotate about the bearing axis. As well, the inner pole may be welded to the lower plate on the top of the plate where the pole contacts the plate in order to secure it. As previously mentioned, the outer vertical pole of the vertical portion will not be welded to the inner sold pole, nor the sedentary part of the base component of the apparatus. This will allow for the entire vertical outer pole portion to be rotatable about the axis of the bearing itself, which may be approximately ⅞ inch thick and 5 inches in diameter. Thus the outer pole may be welded to the top portion of the bearing in order to achieve this movement. This will allow the hook portions to be able to be locked in place, adjusted about a pivot, relocked, etc., at varying angles. This aids in the plumbing process by allowing the sides of the form to be exactly parallel to the rebar cage and in alignment with the 2×4's that hold the base of the form in place when closed and in contact with the floor.

Even more, the lifting truck, which in one embodiment is a fork lift truck, may be operable to manipulate the apparatus at various angles and positions in order to better plumb the form. All control of these adjustments and actions may be made by the operator the fork lift truck, or similar lifting device. This is advantageous this be able to be done solely by the operator of the truck and no additional man power/workers will be necessary on site to manipulate the suspended form to plumb it. Further, this will avoid possible injury to the additional workers when manipulating these heavy forms at dangerous heights and positions. First, the truck may be able to control the forward, aft and lateral movement of the apparatus to the exact position required for engagement of the bracketed hooks with the clamps or similar attachable component located on the side of the form. In addition, the truck may be able to control the vertical movement required to move the bracketed hooks behind the clamps of the form to secure the attachment of the form to the apparatus. In addition, further manipulation of the form for plumbing may be achieved through the tilting forward or aft of the forks on the lift truck.

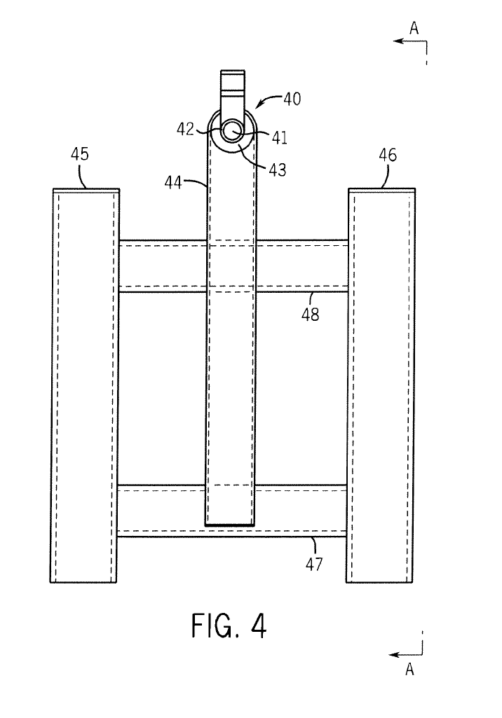

Next, FIG. 4 shows a top view of the vertical portion 40 of the apparatus, with the inner pole 41, outer pole 42 and the bearing 43 attached to the base portion. The vertical portion 40 is positioned on a center portion 44 of the base component that is extended away from the base portion by approximately 12 inches. The center tube portion 44 of the base portion is approximately 48 inches, or 4 feet in length and made from a tube that is 4 inches in height by 6 inch in width and ½ inch thick. The base component is constructed of three tubed steel elements 44, 45, 46. The outer tubes of the base component are slightly shorter at the front portion of the base component and extend past the center tube 44 at the rear portion of the base component. These outer tubes 44, 45, 46 are approximately 48 inches, or 4 feet in length. The vertical component 40 is kept on one side of the apparatus and separated away from the lifting element and the widest part of the apparatus in order for the apparatus not to obstruct the path of the form when attempting to plumb it in the construction site. The outer tubes 45, 46 of the base component are also wider than the center tube 44 in order to allow for increased stabilization of the apparatus along with sufficient inner openings to accommodate fork lift entry. In one embodiment, these outer tubes 45, 46 are approximately 4 inches in height×8 inches in width.

The three parallel tubes are crossed by two horizontal tubes 47, 48 to form the overall square base component of the apparatus. The two horizontal tubes 47, 48 lie in the front of the base component, near the vertical component, and the back of the base component. These horizontal tubes 47, 48 lie flush with the plane of the outer tubes 45, 46 and below the plane of the central tube. The central parallel and slightly thinner tube 44 comes to an end on the back horizontal tube, whereas the outer two parallel tubes continue slightly past it. The outer tubes 45, 46 may extend approximately 6 inches past the back horizontal tube portion and the approximately 6 inches past the front horizontal tube portion. All tubes may be made of steel or similar durable metal which may secure large loads. As well, all portions of the tubing may be welded to pieces of crossed tubing were necessary, such as where the horizontal tubes contact the outer parallel tubes and the upper central parallel tube.

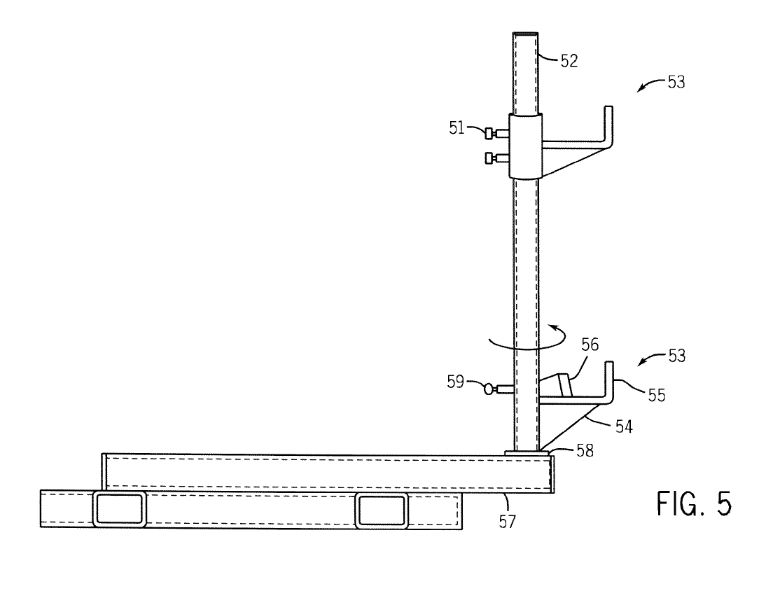

Finally, FIG. 5 provides a cross-sectional view of the apparatus. As shown in one embodiment, the outer tubed portions (4 inch×8 inch) of the base component have center openings of approximately 6 inches in width by 3 inches in height. As previously mentioned, these openings are provided in order for the fork lift or other lifting element to be inserted in order to raise the apparatus up to the height at which the form is to be placed. Since the fork lift element is unnecessary on the front portion, to the left and right of the vertical element, the tube openings may be closed shut with metal or similar material. As well, the two horizontal tubes may be closed on each end portion or left open, depending on necessity for side lifting of the form. Since the form is much larger than the apparatus, it is more easily plumbed since the fork lifting has better control over the movement and placement of the apparatus and, in turn, the form itself. The apparatus, feasibly holds up to 1000 pounds (lbs) at the point of the bearing plate, which is located approximately 8 inches above the ground plane.

Finally, a chain element may be located through the center portion of the central parallel tube, which holds the vertical components of the apparatus for additional support.

As previously mentioned, the configuration of the hooking fixture apparatus utilized in conjunction with the lift truck accomplish form positioning and form removal from the side, rather than from the top of the forms. The adjustability of the hook elements, particularly the upper adjustable bracket 50 provide a modifiable configuration which may be utilized within each structural development. Additional brackets may even be added onto the top of the vertical pole 52 as needed and taken off as needed. The brackets may be adjusted along the vertical pole 52 through usage of bolts 51 which fit into holes that may be drilled along one side of the pole. The bolts may be thread through a nut which is welded onto the bracket structure for security. In one embodiment, the bottom bracket 53 is welded to the pole, yet rotatable about the pole. The outer pole itself may also pivot about the bearing 58 located at the bottom of the pole and above the center tube 57.

As shown in FIG. 5, the lower bracket has a slightly higher outer lip, or hook portion 55 and an inner hook portion 56 for securing the form. Dependent on the weight and type of maneuvering, the form may also be further secured through usage of a bolt through the holes located through the lips, or hook portions, of the lower bracket. Though these are preferred embodiments, it is understood that the brackets may be further modified according to specific types of forms being frequently utilized. In another embodiment, where the bottom bracket is welded to the outer vertical outer pole 52, the bolt 59 may be welded to the vertical outer pole 52. In addition the bracketed hooks may be adjusted and modified to specific angles to which the form is to be plumbed. This may be done by the bracket or by the angling of the entire apparatus with the brackets remaining with hooks perpendicular to the vertical pole portion of the apparatus. The bracket may also contain a brace 54 underneath which will aid in the strain placed on the hook structure during lifting of heavier column forms. The brace 54 may extend from the outer edge of the hook 55 on the bracket to the base of the bracket 53 itself. As well, it may be welded to the vertical portion 52 of the bracket and bottom of the hook 55 in order to secure it.

While particular embodiments of the present invention have been disclosed, it is to be understood that various different modifications and combinations are possible and are contemplated within the true spirit and scope of the appended claims. There is no intention, therefore, of limitations to the exact abstract and disclosure herein presented.

What is claimed is:

1. An apparatus for use with construction of concrete through forms, comprising:
a fixture attached to a lifting vehicle;
a vertical component having an inner portion and an outer portion;
a base component configured to support the vertical component, the base component having two or more parallel portions crossing two or more perpendicular parallel portions; and
two or more brackets on the vertical component, wherein the brackets contain hook elements on one side.

2. The apparatus of claim 1, wherein the outer portion of the vertical component is a hollow metal pipe.

3. The apparatus of claim 2, wherein the pipe measures between about 4 and about 6 inches in diameter.

4. The apparatus of claim 2, wherein the pipe has a wall with a thickness of about ½ inches.

5. The apparatus of claim 4, wherein the outer portion of the vertical component is welded to a bearing plate.

6. The apparatus of claim 5, wherein the outer portion of the vertical component is rotatable about the inner portion.

7. The apparatus of claim 1, wherein the inner portion of the vertical component is a solid pole fitted within the outer portion.

8. The apparatus of claim 7 wherein the inner portion is between about 3 and about 5 inches in diameter.

9. The apparatus of claim 1, wherein the vertical component contains notches that are spaced apart.

10. The apparatus of claim 9, wherein at least one bracket is vertically adjustable on the vertical component.

11. The apparatus of claim 10, wherein the bracket is configured to be adjusted and secured with a bolt through one of the notches located on the vertical component.

12. The apparatus of claim 11, wherein the bolt is between 0.5 and 1.5 inches in diameter.

13. The apparatus of claim 1, wherein the brackets include a brace.

14. The apparatus of claim 1, wherein the base component includes two or more tube portions.

15. The apparatus of claim 1, wherein the vertical component includes a bearing plate having a hole for insertion of the inner portion of the vertical component therethrough.

16. The apparatus of claim 15, wherein the bearing is about ⅞ inch thick.

17. The apparatus of claim 15, wherein a lower bracket is attached to the vertical component.

18. A method of plumbing forms, comprising:
attaching a form to an apparatus, the apparatus having a vertical component, a base component and two or more brackets containing hooks and located on the vertical component;
adjusting at least one bracket about the vertical component;
aligning the form; and
plumbing the form.
